(19) United States
(12) Patent Application Publication
(10) Pub. No.: US 2002/0010934 A1
(43) Pub. Date: Jan. 24, 2002

(54) Information service providing system and method of same

(76) Inventor: Koichi Matsuda, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/832,908

(22) Filed: Apr. 12, 2001

(30) Foreign Application Priority Data
Apr. 13, 2000 (JP) P2000-117181

(51) Int. Cl. H04N 7/20

(52) U.S. Cl. 725/64

(57) ABSTRACT

A bidirectional information service providing system comprised of an uplink and a downlink of a satellite communication network comprising a transmitting means for transmitting content information to a user by a downlink, a receiving means for receiving a request signal from a user by an uplink in a predetermined time band, and a control means for making the transmitting means transmit certain content information at a certain time in response to the request from the user received by the receiving means.

### BACKGROUND OF THE INVENTION

1. Field of the Invention

The present invention relates to a bidirectional information service providing system comprised of a communications line using a telecommunications satellite and a method of providing such a service.

2. Description of the Related Art

The main bidirectional information services targeting general home users in the related art are Internet connection services. At present, Internet connection services can be realized not only through usual telephone networks, but also through even a cable television (CATV) broadcast systems and ground wireless communications systems.

Summarizing the problems to be solved by the invention, the bidirectional information service systems of the related art all have their disadvantages. For example, in a bidirectional information service using a telephone network, high speed data transmission is impossible because the communication speed of a telephone line is 128 kbps (kilobits per second) even at a maximum. Further, it requires a dial up operation and therefore is troublesome.

On the other hand, in a bidirectional information service using the cable television broadcasting system, while there are advantages that high speed data transmission can be realized and a large quantity of information data can be transmitted at a high speed, the service can be provided only in service areas of the cable television broadcasting system and infrastructure investment for the construction of the cable network etc. becomes necessary in order to provide service over a wider area. Further, at present, cable television service providers face numerous regulations on producing original content, so the content they can provide is limited.

Further, in a bidirectional information service using a ground wireless communication network, the service can be provided only in the area that the radio wave reaches. Further, it is difficult to distribute a large volume of content as stream data because of the limitations of the communication capacity.

### SUMMARY OF THE INVENTION

An object of the present invention is to provide an information service providing system and a method of the same that realize a larger capacity and wider area information service system by using a satellite communication circuit network, provide high quality content information for users by using a large capacity of a downlink and provide a complete bidirectional information service by using an uplink.

According to a first aspect of the present invention, there is provided a bidirectional information service providing system comprised of an uplink and a downlink of a satellite communications network comprising a transmitting means for transmitting content information to users by the downlink, a receiving means for receiving a request signal from the user by the uplink in a predetermined time band, and a control means for making the transmitting means transmit certain content information at a certain time in response to the request from the user received in the receiving means.

Preferably, the content information is generated based on a moving picture signal or a high quality music signal.

More preferably, the transmitting means adds predetermined additional information to the content information for transmission. Note that the additional information is packet data generated according to a predetermined communication protocol.

Further preferably, the user transmits user information to a provider of the information service by the uplink. Note that the user information is packet data generated according to a predetermined communication protocol.

Still further preferably, a provider of the information service informs the user of the predetermined time band of the receiving means in advance.

Further preferably, a provider of the information service provides a certain service to the user in accordance with an order from the user transmitted by the uplink, for example, a product ordered by the user.

According to a second aspect of the present invention, there is provided an information service providing method in a bidirectional information service providing system comprised of an uplink and a downlink of a satellite communication network, comprising a step of transmitting content information to a user by the downlink, a step of receiving a request signal from a user by the uplink in a predetermined time band, and a step of transmitting certain content information at a certain time in response to the request from the user.

Preferably, a provider of the information service adds predetermined additional information to the content information to transmit it to the user.

Further preferably, the user transmits user information, for example, a request for transmission of certain content information, to a provider of the information service by the uplink.

### BRIEF DESCRIPTION OF THE DRAWINGS

These and other objects and features of the present invention will become clearer from the following description of the preferred embodiments given with reference to the accompanying drawings, in which:

FIG. 1 is a view of the configuration of an embodiment of an information service system according to the present invention;

FIG. 2 is a view of state of use of a service by a user at home;

FIG. 3 is a block diagram of the configuration of a satellite communication modem;

FIG. 4 gives views of examples of a television screen relating to viewing of information on advertising products and orders;

FIG. 5 is a view of an example of a communication protocol used in the service providing system of the present invention; and

FIG. 6 is a view of an operation of a service providing content information by a multicast.

### DESCRIPTION OF THE PREFERRED EMBODIMENTS

Below, preferred embodiments will be described with reference to the accompanying drawings.

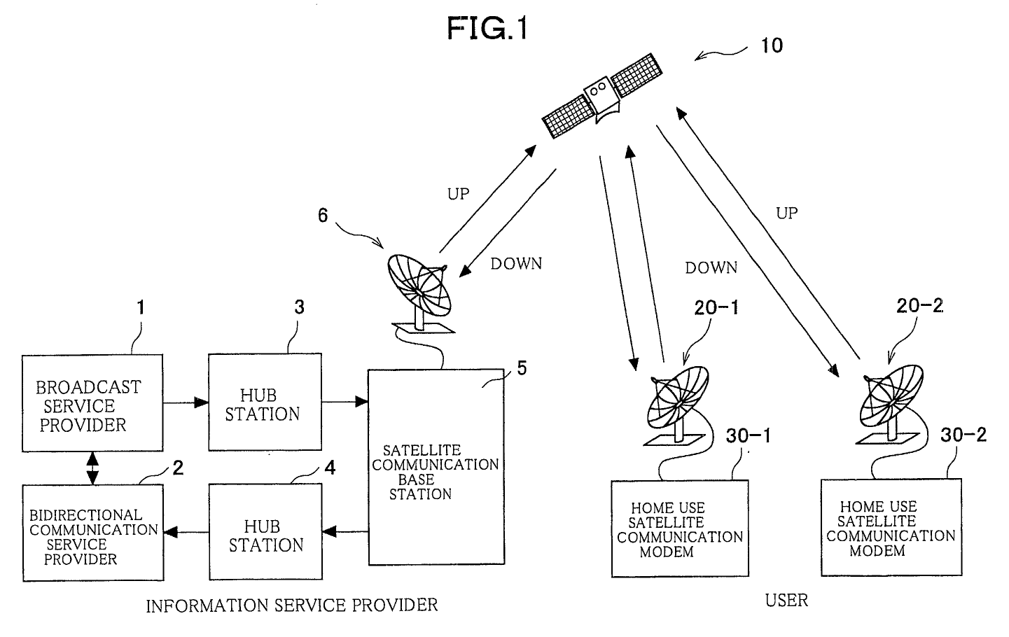

FIG. 1 is a view of an example of an information service system according to the present invention and a view of the configuration of an information service system as a whole.

As shown in the figure, the information service system 1 according to the present invention comprises a broadcast service provider 1, a bidirectional communication service provider 2, a hub station 3, a hub station 4, a satellite communication base station 5, a station use transmitting and/or receiving antenna 6, a communication satellite 10, home use transmitting and/or receiving antennas 20-1 and 20-2, and home use transmitting and/or receiving modems 30-1 and 30-2.

The broadcast service provider 1 generates content for broadcasting based on the broadcasting use information and broadcasts it to the users via the hub station 3, the satellite communication base station, the antenna 6, and the communication satellite 10. Note that the broadcast user content generated by the broadcast service provider 1 is generated for example based on a moving picture and a high quality audio signal. The broadcast use content is constantly transmitted for the time band in which stream type information is broadcast, that is, in which the provider is broadcasting. This stream type content information is substantially the same as the content information broadcast by a digital satellite television broadcast, ground digital television broadcast, or digital radio broadcast. However, richer service content than before is provided to the user of each home to the increase of the communication capacity of the communications satellite in addition to the signal processing by high efficiency encoding.

Further, the broadcast service provider 1 adds predetermined additional information to the content information and transmits it to the users. The additional information is for example packet data generated in accordance with a predetermined communication protocol (data block generated in accordance with the predetermined communication protocol), that is, generated in accordance with the service information according to the service guide of the provided content information, information of the advertised goods, and the method of ordering goods.

The bidirectional communication service provider 2 provides a predetermined information service to a user by a bidirectional communication line such as an Internet connection. Further, it receives information transmitted from the user and provides the predetermined service in response to it. In this embodiment, the bidirectional communication service provider 2 provides the predetermined information to the user by a downlink of the satellite communication and collects the information contributed from users to provide it to the broadcast service provider or to provide the predetermined service to the users in response to the requests of the users.

The hub stations 3 and 4 are connected to the broadcast service provider 1 and between the bidirectional communication service provider 2 and the satellite communication station 5. For example, the hub station 3 transfers the content information generated by the broadcast service provider 1 to the satellite communication base station 5, while the hub station 4 transfers the information received by the satellite communication base station 5 from the user to the bidirectional communication service provider 2. Note that while only two hub stations 3 and 4 are shown in FIG. 1, the number of the hub stations is not limited to the specific number in the information service system of the present embodiment, so a broadcast service provider or a bidirectional communication service provider can transmit and/or receive information with the satellite communication base station 5 by a plurality of hub stations and a hub station can handle a plurality of broadcast service providers and a plurality of bidirectional communication service provider.

The satellite communication base station 5 transmits the content information transmitted from the hub station 3 to the communication satellite 10 by the station use antenna 6, receives the user information transmitted from the communication satellite 10 by the station use antenna 6, and transmits it to the predetermined bidirectional communication service provider by the hub station 4.

The station use antenna 6 is a transmission and reception use antenna for transmitting and receiving signals between the satellite communication base station 5 and the communication satellite 10. Here, though the station use antenna 6 is for both transmitting and receiving, an antenna for the transmission and an antenna for the reception may be set separately.

The uplink for transmitting from the satellite communication base station 5 to the communication satellite 10 uses the frequency band of for example 14.00 to 14.50 GHz, while the downlink for transmitting from the communication satellite 10 to the satellite communication base station 5 uses the frequency band of for example 12.15 to 12.75 GHz.

The communication satellite 10 receives the signal transmitted from the station side by the uplink, converts the frequency of the received signal, amplifies it, and transmits it to each home by the downlink. Further, the communication satellite 10 receives signals transmitted from users of each home by the uplink, converts the frequency of the received signals, amplifies them, and transmits them to the satellite communication base station 5 by the downlink. Note that, the uplink and the downlink between the communication satellite 10 and the homes may use the same frequency band as or different frequency bands from the uplink and the downlink between the communication satellite 10 and the satellite communication base station 5.

The home use transmission and reception antennas 20-1 and 20-2 are transmission and reception antennas set at each home and receive signals transmitted from the communication satellite 10 by the downlink, output the received signals to each of the home use satellite communication modems 30-1 and 30-2, and transmit the user information transmitted from each of the home use satellite communication modems 30-1 and 30-2 to the communication satellite 10 by the uplink. Note that, as the home use transmission and reception antennas 20-1 and 20-2, for example, an approximately same antenna as a reception antenna (diameter about 45 cm) for communication satellite (CS) broadcasts may be used.

The home use satellite communication modems 30-1 and 30-2 demodulate the signals received by the home use transmission and reception antennas 20-1 and 20-2, divide the multiplexed signals from the received signals, and output signals decoded in accordance with a predetermined decoding method. For example, they demultiplex the content signals from the receiving signals, decode them, reproduce them, and output the moving picture signals to the televisions and output the audio signals to audio devices. Further, they transmit signals for home use network terminals to the home use network terminals.

By the service system mentioned above, the content information, for example, a moving picture signal and a high quality audio signal, generated by the broadcast service provider 1 may be transmitted to the user of each home as stream type content. Further, the bidirectional communication service provider 2 realizes bidirectional communication to the user of each home by using the uplink and the downlink. Therefore, complete bidirectional communication is realized by the satellite communication circuit without using a usual telephone line, so large volume, high quality bidirectional communication is realized. For example, it can transmit the content information such as a moving picture and an audio from the broadcast service provider 1 to the user of each home with the communication speed of 67 Mbps (Megabits per second), so broadcasting with higher quality video and audio signals than television broadcasting in the related art is realized. Further, each user can transmits the user information to the bidirectional communication service provider 2 with a communication speed of 128 to 256 Kbps and can use the Internet for a higher speed and lower charge than a telephone line in the related art.

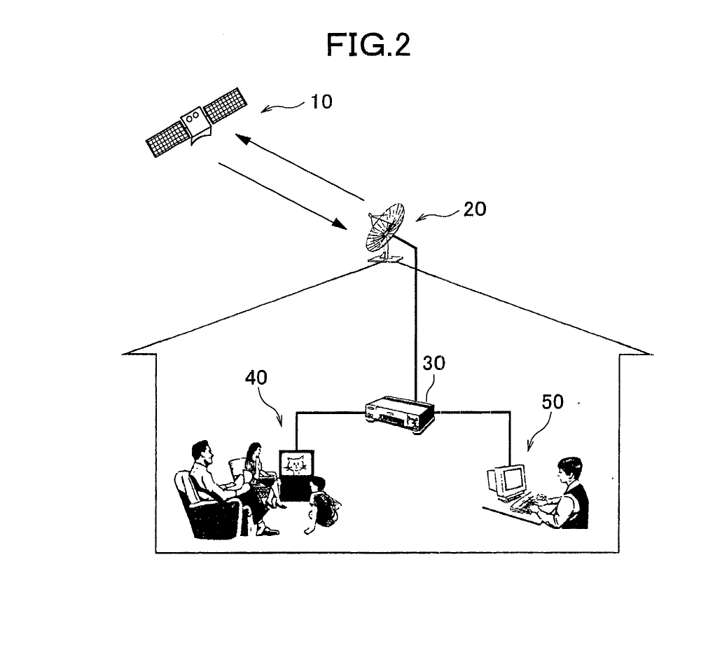

FIG. 2 is a view of the state of use of the information service system in each home. As shown in the figure, each home can receive content information and can utilize an Internet connection or other bidirectional communication service through the home use transmission and reception antenna 20 and the home use satellite communication modem 30.

The content information transmitted from the communication satellite 10 by the downlink is received by the transmission and reception antenna 20 and input to the satellite communication modem 30.

The satellite communication modem 30 is a signal processing apparatus mounted in what is called a set up box (STB). The satellite communication modem 30 demodulates, demultiplexes, and decodes a signal received by the transmission and reception antenna 20 to generate an image signal and a high quality audio signal and outputs them to the television 40 or audio device. Further, it demultiplexes packet data transmitted on the Internet and outputs it to the network terminal device 50. On the other hand, it encodes information such as a request signal, an answer to a questionnaire, and an order of goods output from the television 4. Further, it adds the packet data output from the network terminal device 50 to them, modulates the signal in accordance with a predetermined modulation method, and outputs it to the transmission and reception antenna 20.

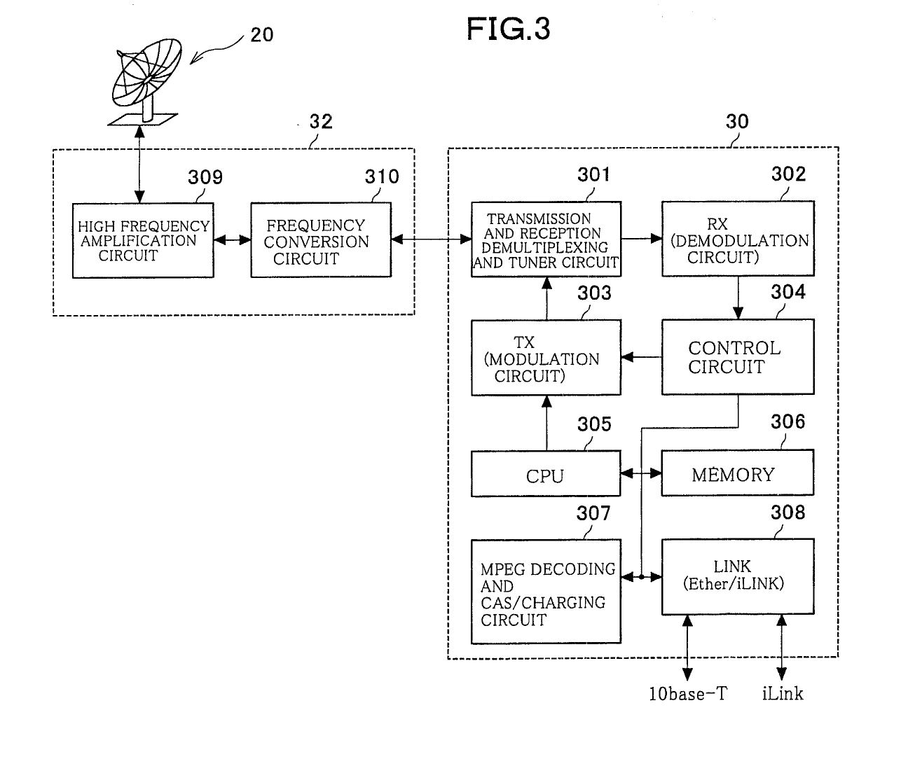

FIG. 3 is a block diagram of the configuration of the satellite communication modem 30 and the antenna converter 32. As shown in the figure, the satellite communication modem 30 comprises a transmission and reception demultiplexing and tuner circuit 301, a demodulation circuit (RX) 302, a modulation circuit (TX) 303, a control circuit 304, a CPU 305, a memory 306, a MPEG decoding and CAS/charging circuit 307, and a link circuit 308.

The antenna converter 32 is connected between the transmission and reception antenna 20 and the satellite communication modem 30. The antenna converter 32 comprises a high frequency amplifier 309 and a frequency conversion circuit 310. Note that, the antenna converter 32 is generally mounted in the transmission and reception antenna 20.

The frequency conversion circuit 310 converts a signal with a middle frequency output from the satellite communication modem 30 to the high frequency signal and outputs it to the high frequency amplifier 309. Further, it converts the signal output from the high frequency amplifier 309 to a middle frequency signal and outputs it to the satellite communication modem 30.

The high frequency amplifier 309 amplifies the signal output from the frequency conversion circuit 310 and outputs it to the transmission and reception antenna 20. Further, it amplifies the high frequency signal received by the transmission and reception antenna 20 and outputs it to the frequency conversion circuit 310.

Below, the configurations and functions of each portion of the satellite communication modem 30 will be explained.

The transmission and reception demultiplexing and tuner circuit 301 outputs a transmission signal from the modulation circuit 303 to an external output terminal (not shown) of the modem 30. Further, it tunes a desired channel from the signal input from the external input terminal and outputs the signal of the channel to the reception circuit 302. Note that, the external output terminal and the external input terminal mentioned above are, for example, respectively connected to the frequency modulation circuit 310 of the antenna converter 32. Here, because the frequencies of the transmission signal and the reception signal are different, the transmission and reception demultiplexing and tuner circuit 301 comprises the function of a diplexer which can handle signals with different frequencies at the same time.

The reception circuit 302 receives the signal output from the transmission and reception demultiplexing and tuner circuit 301 and demodulates it. For example, the reception circuit 302 includes a demodulation portion which demodulates a baseband signal. A bit stream is output by the reception circuit 302 to the control circuit 304.

The transmission circuit 303 modulates the transmission data output from the control circuit 304 in accordance with a predetermined modulation method and outputs it to the transmission and reception demultiplexing and tuner circuit 301.

The control circuit 304 demultiplexes the received signal from the reception circuit 302 and, for example, outputs the bit stream of the content information to the television or the audio device and outputs the packet data to the network terminal. Further, it outputs the signals output from each of the devices to the transmission circuit 303.

The CPU 305 controls the operation of each portion of the satellite communication modem 30. Further, it reads out the control program recorded in the memory 306 and carries out the predetermined processing in accordance with the program.

The memory 306 stores the control program for the CPU 305 to control the satellite communication modem 30 and the data necessary to control the operation. The data recorded in the memory 306 is refreshed under the control of the CPU 305.

The MPEG decoding and CAS/charging circuit 307 decodes the bit stream output from the control circuit 304 in accordance with the MPEG decoding method to generate a moving picture signal. Note that, when the MPEG encoded moving picture information is provided as pay data by the broadcast service provider 1 or the bidirectional communication service provider 2, the MPEG decoding and CAS/charging circuit 307 carries out the processing to collect a viewer charge from the user in accordance with the charging information included in the bit stream. For example, the viewer charge is calculated in predetermined units, for example in monthly units. The total of the viewer charge of every month may be deducted from a bank account specified by the user or may be settled by a credit card specified by the user.

The link circuit 308 is an input and/or output circuit for outputting the moving picture signal decoded by the MPEG decoding and CAS/charging circuit 307, the high quality audio signal, and the packet data output from the control circuit 304 to the television, the network device, and so on and for outputting the output signal from these devices to the control circuit 304. As shown in figure, the input and output of the signal are carried out via the 10 base-T connection of the Ethernet or the i-link (iLink) connection.

The bidirectional communication between a user in the home and the communication satellite is realized by using the satellite communication modem 30 of the configuration mentioned above. The signal transmitted from the communication satellite is received by the transmission and reception antenna 20 and the received signal is demultiplexed and demodulated by the satellite communication modem 30. For example, the moving picture signal and the high quality audio signal is decoded in accordance with each of the predetermined decoding methods and the moving picture signal and audio signal are reproduced and provided to the television and the audio device. On the other hand, the packet data for network communication included in the received signal is transferred to the network terminal. The user information transmitted from the network terminal is encoded and modulated by the satellite communication modem 30 and transmitted to the communication satellite by the transmission and reception antenna 20.

As mentioned above, the usual connection type bidirectional communication is realized for a user in the home by the satellite communication line. The content information including television programs and high quality music signals is transmitted from the provider to the user via the large capacity communication line. User information such as requests from a user and answers to a questionnaire is transmitted to the provider in accordance with predetermined communication protocol by the packet exchange method. Therefore, complete bidirectional communication can be realized with low cost without the usage of a normal telephone circuit, the various content information may be provided with a high quality to the user, and requests, orders, etc. the user to the content provider may be fed back at all times, so an information service system with a high degree of the satisfaction can be realized.

Next, the framework for transmitting user information by using the Internet protocol (IP) packets multiplexed in the image information displayed on the television will be explained. Note that an IP packet is packet data generated in accordance with the IP.

The television 40 receives the video signal and the audio signal output from the satellite communication modem 30, displays the video signal on a screen, and outputs the audio signal to a speaker. The content information transmitted from the communicating satellite 10 is mainly stream type information. However, this information is not monodirectional information. For example, the IP packet is multiplexed in the stream. The user watching the television program can request a program, view information on the advertised goods, order goods, and answer a questionnaire in response to data of the IP packet in accordance with the message displayed on the television screen.

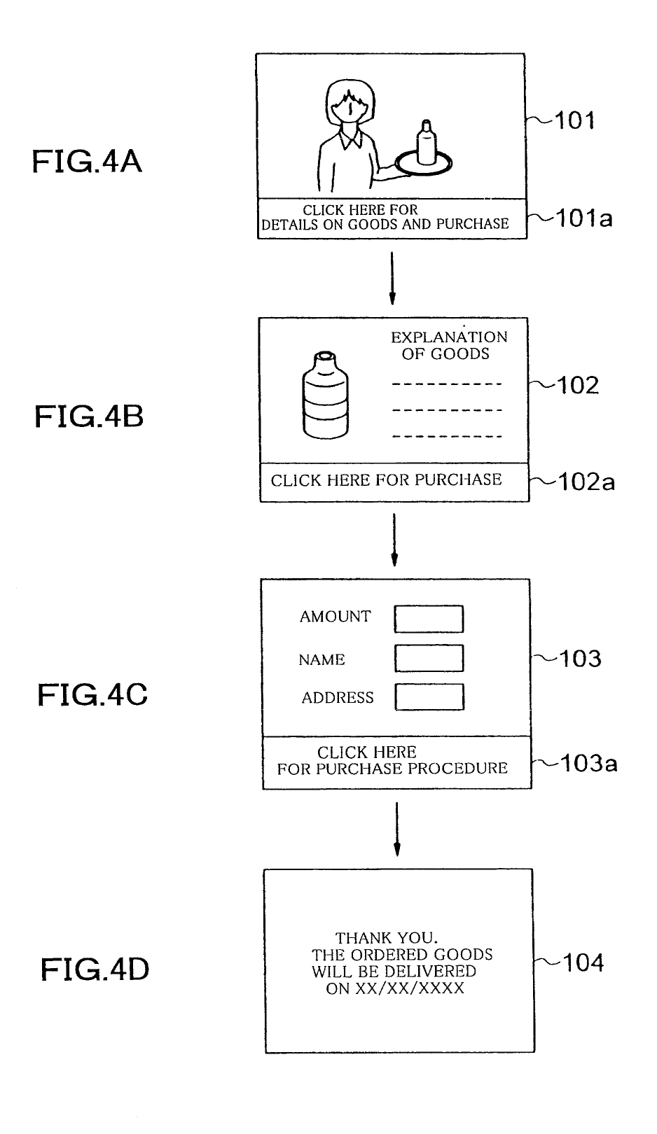

FIG. 4 gives views of examples of screen displays for viewing information on the advertised goods and ordering goods. The advertising data is inserted in the information contents provided by the broadcast service provided in addition to the usual television program. Further, when advertising information is transmitted, the data for providing the information of the advertised goods and for receiving the order of the goods are transmitted by IP packets at the same time. At the receiving side, the advertising information (including the moving picture signal and the audio signal) included in the stream received by the satellite communication modem 30 is reproduced and output to the television. At the same time, the IP packet data included in the stream is reproduced, and a message according to the advertised goods is displayed on the television screen in accordance with the reproduced data in addition to the image of the advertised goods.

FIG. 4 shows examples of the television screens in this case. As shown in FIG. 4A, a message for providing information on goods and receiving an order is displayed, for example, at the bottom of the advertising picture 101. When the user watching the display wants detailed information about the advertised goods, the user clicks the area of the screen of the message 101a with the keyboard and pointer. By this operation, user information indicating the user wants information about the advertised goods is generated by the information processor in the television and output to the satellite communication modem 30. In the satellite communication modem 30, the user information transmitted from the television is transmitted to the transmission circuit 303 via the control circuit 304. IP packets are generated based on the user information and transmitted with the output signal from another device such as the network after the predetermined encoding and multiplexing. The output signal is transmitted to the program producing side after frequency conversion and amplification by the transmission and reception antenna 20 via the satellite communication circuit.

The program provider provides information to the user in response to the received user information. For example, it forms the IP packets in response to the information relating to the details of the advertised goods and multiplexes the packets with the content information to transmit them to the user.

At the user side, the satellite communication modem 30 reproduces the received IP packet data. As shown in FIG. 4B, messages such as the explanation of the advertised goods 102 and the method of ordering 102a are held on the television screen.

When the user watching the explanation of the goods wants to buy the goods, the user clicks the area of the message of the desired goods on the screen by using the input apparatus mentioned above. As a result, the information processor mounted in the television generates the information indicating that the user wants to buy the goods and transmits the information to the satellite communication modem 30. In the satellite communication modem 30, the IP packet is generated in response to the information transmitted from the television and transmitted to the program provider side by the satellite communication modem 30.

The program provider side transmits information for receiving the order to the user side as the IP packet data in response to the received information from the user together with the content information to the user side. The television screen of the user receiving the information, as shown in FIG. 4C, displays the messages 103 and 103a for receiving the order of the goods.

The user inputs the information such as the quantity of the goods and his name and address and clicks the area of the purchase procedure message 103a on the screen.

The order information of the user is transmitted to the satellite communication modem 30. IP packets are generated in response to this and transmitted to the program provider side via the satellite communication circuit. The program provider side confirms the content of the order of the user based on the received information and transmits information indicating that the order is received and other information for displaying the message as IP packet data with the content information. At the user side that receives this, for example, the message 104 shown in FIG. 4D is displayed on the television screen. Note that, the price of the ordered goods is collected for example by the method of payment the user registers at the program provider in advance.

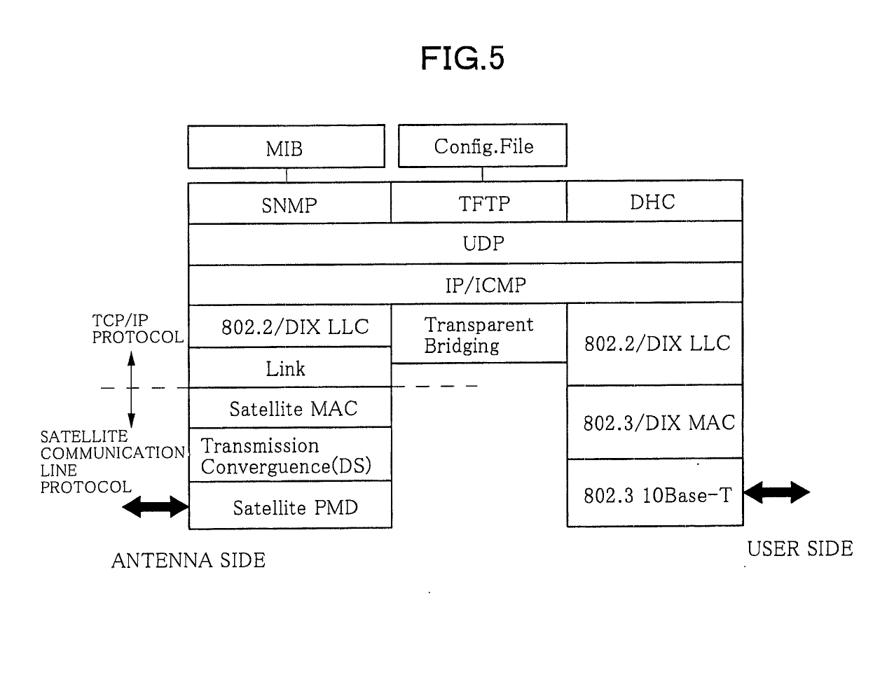

FIG. 5 shows an example of the communication protocol used in the information service system of the present embodiment. As shown in the figure, this protocol is a combination of the transmission control protocol/Internet protocol (TCP/IP) used for data transfer on the usual network and the protocol for the satellite communication. At the user side, the IP packets are generated in accordance with the protocol based on the information transmitted to the broadcast service provider 1 or the bidirectional communication service provider 2 and transmitted to the broadcast service provider 1 or the bidirectional communication service provider 2 by the transmission and reception antenna 20 and the communication satellite 10. Further, at the side of the broadcast service provider 1 or the bidirectional communication service provider 2, the IP packets are added to the stream of the content information in accordance with the protocol and transmitted to the user by the communication satellite 10. At the user side, the IP packets received by the transmission and reception antenna 20 are divided from the content stream, and the original information data is reproduced in accordance with the protocol.

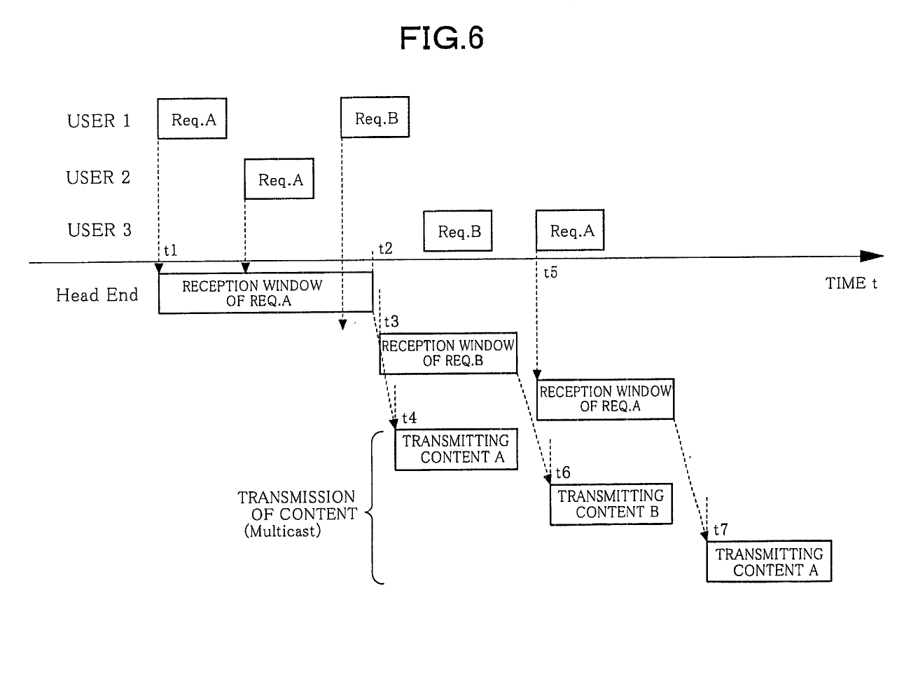

FIG. 6 is a view of an example of the method of the information service in the information service system of the present embodiment. In the information service system of the present embodiment, for example, the content information is provided to a plurality of users by the broadcast service provider. Further, a request from the user may be received via the bidirectional communication line between the broadcast service provider and the user, so the information of the content that the user desires is provided.

Here, if the provided content information is generated for example from a moving picture signal and a high quality audio signal, the transmission of the content information requires a larger capacity transmission line. For example, the communication capacity of the forward link (the link for transmitting from a provider to a user via a communication satellite) of a satellite communication line is, in the case of a digital satellite communication line employed at present, 30 to 65 MHZ. When transmitting a large amount of content information to many users at the same time, in the uni-cast method of one-to-one communication between the provider and the user in the related art, there is the possibility that the line capacity cannot keep up. Therefore, the multi-cast method of the provider transmitting the same content to a plurality of users at the same time is efficient instead of the uni-cast method.

FIG. 6 shows an example of the operation of an information service system which provides requested content information to a plurality of users under the multi-cast method. In this example, a predetermined time window is provided and requests from a plurality of users are received in the time window. After the time window closes, the specific content information is transmitted in response to the requests received from the plurality of users while the time window was open. By the provider providing a plurality of contents sending the times when the reception windows of contents open to the users in advance as service information, the users can plan the time for requests to receive the desired content information in advance. By providing a plurality of time windows shifted slightly on the time axis, almost all users may obtain the desired content information quickly without inconvenience.

Below, the establishment of the time windows and the transmission timing of the information will be explained referring to FIG. 6. Note that, in FIG. 6, illustration is given of the case where three users, namely the user 1, the user 2, and the user 3, are receive the provision of the service and the information service provider provides two content information, namely, content A and content B, but in an actual information service system, the number of the users can become larger and the service provider can provide a plurality of contents to each of the users at the same time.

The reception window for receiving requests for the content A is opened from the time t1 to receive requests of the content A from the users. While the reception window for the content A is open, requests from the user 1 and the user 2 are received. The reception window for the content A closes at the time t2. The broadcast service provider transmits the content A from the time t4 in response to the requests of the user 1 and the user 2 received when the reception window was opened. The user 1 and the user 2 who requested the content A receive the broadcasting of the content A broadcast from the time t4 and can enjoy the moving picture and the high quality audio of the content that the users desired.

The broadcast service provider establishes the reception window for the content B from the time t3. While the window is open, a request for the content B is transmitted from the user 3. Note that a request transmitted at a time other than the time when the reception window for the content B is open cannot be received. For example, as shown in the figure, a request for content B is transmitted from the user 1 before the reception window for the content B opens, but cannot be accepted. The broadcast service provider starts to transmit the content B from the time t6 in response to the request from the user 3 received at the time when the reception window opens. The user 3 who requests the content B receives the information of the content B from the time t6 to obtain the desire information.

Further, the broadcast service provider opens the reception window for the content A again from the time t5. While this reception window is open, for example, a request for the content A from the user 3 is accepted. In response to this, the broadcast service provider starts to transmit the content A from the time t7, so the user 3 receives the content A and can enjoy the desired moving picture and the high quality music.

As explained above, according to the present embodiment, a time window corresponding to certain content is established by the information service provider and requests for certain content transmitted from a plurality of users in the time window are accepted. Then, after the time window closes, the provider transmits the content from a predetermined time in response to the received requests. By transmitting the content by the multi-cast method, the congestion of the communication lines may be avoided and the communication lines may be used efficiently, so it is possible to provide more content information to users using the existing communication lines.

Note that the present invention is not limited to the above embodiments and includes modifications within the scope of the claims.

Summarizing the effects of the invention, as described above, according to the present invention, continuous bidirectional communication may be realized using satellite communication lines, so a large amount of the content information may provided from the service provider to the user via high speed communication lines and the service provider can receive information such as orders and requests from the user at the same time. Further, at the user side, the Internet connection on the network terminal may be realized by using the bidirectional communication lines, so the user can obtain a large amount of information at a low cost.

Further, according to the information service system and the method of same of the present invention, by receiving requests from a plurality of users intensively by establishing a time window and transmitting the content information in response to the requests from the users after the time window, the congestion of the communication lines may be avoided and the communication lines may be used efficiently.

While the invention has been described with reference to specific embodiments chosen for purpose of illustration, it should be apparent that numerous modifications could be made thereto by those skilled in the art without departing from the basic concept and scope of the invention.

What is claimed is:

1. A bidirectional information service providing system comprised of an uplink and a downlink of a satellite communication network comprising:
a transmitting means for transmitting content information to a user by said downlink;
a receiving means for receiving a request signal from said user by said uplink in a predetermined time band; and
a control means for making said transmitting means transmit certain content information at a certain time in response to said request from the user received in said receiving means.

2. A bidirectional information service providing system as set forth in claim 1, wherein said content information is generated based on a moving picture signal.

3. A bidirectional information service providing system as set forth in claim 1, wherein said content information is generated based on a high quality music signal.

4. A bidirectional information service providing system as set forth in claim 1, wherein said transmitting means adds predetermined additional information to said content information for transmission.

5. A bidirectional information service providing system as set forth in claim 4, wherein said additional information is packet data generated according to a predetermined communication protocol.

6. A bidirectional information service providing system as set forth in claim 1, wherein said user transmits user information to a provider of said information service by said uplink.

7. A bidirectional information service providing system as set forth in claim 6, wherein said user information is packet data generated according to a predetermined communication protocol.

8. A bidirectional information service providing system as set forth in claim 1, wherein a provider of the information service informs said user of said predetermined time band of said receiving means in advance.

9. A bidirectional information service providing system as set forth in claim 1, wherein a provider of the information service provides certain service to said user based on an order transmitted by said uplink from said user.

10. A bidirectional information service providing system as set forth in claim 1, wherein a provider of the information service provides an ordered item to said user based on an order transmitted by said uplink from said user.

11. An information service providing method in a bidirectional information service providing system composed of an uplink and a downlink of a satellite communication network, comprising:
a step of transmitting content information to a user by said downlink;
a step of receiving a request signal from said user by said uplink in a predetermined time band; and
a step of transmitting certain content information at a certain time in response to said request from the user.

12. A information service providing method as set forth in claim 11, wherein a provider of the information service adds predetermined additional information to said content information to transmit it to said user.

13. A information service providing method as set forth in claim 12, wherein said additional information is packet data generated according to a predetermined communication protocol.

14. A information service providing method as set forth in claim 11, wherein said user transmits user information to a provider of said information service by said uplink.

15. A information service providing method as set forth in claim 14, wherein said user information is packet data generated according to a predetermined communication protocol.

16. A information service providing method as set forth in claim 14, wherein said user information is a request for transmission of certain content information.
